(19) United States
(12) Patent Application Publication
(10) Pub. No.: US 2010/0201611 A1
(43) Pub. Date: Aug. 12, 2010

(54) LED DISPLAYS

(75) Inventors: Dung T. Duong, Cedar Park, TX (US); Paul N. Winberg, Rollingwood, TX (US)

Correspondence Address: SPRINKLE IP LAW GROUP, 1301 W. 25TH STREET, SUITE 408, AUSTIN, TX, 78705, US

(73) Assignee: Illumitex, Inc., Austin, TX (US)

(21) Appl. No.: 12/645,316

(22) Filed: Dec. 22, 2009

Related U.S. Application Data
(60) Provisional application No. 61/140,170, filed on Dec. 23, 2008.
(60) Provisional application No. 61/140,140, filed on Dec. 23, 2008.

(51) Int. Cl. G09G 3/32

(52) U.S. Cl. 345/83

(57) ABSTRACT

Embodiments described herein provide LED displays. One embodiment of an LED display can comprise an array of white light units with each white light unit comprising a set of color light sources. The display can further include a controller electrically coupled to the white light units, the controller configured to control the white light units to alter the color of light produced by the white light units to produce images on the display. Another embodiment of a display can comprise an array of red light sources, green light sources and blue light sources configured to provide light to a color combiner in a desired half angle and a color combiner configured to combine light into a common plane for transmission to the projection optic.

### RELATED APPLICATIONS

This application claims priority under 35 U.S.C. §119(e) to U.S. Provisional Patent Application No. 61/140,170, entitled “LED Display” filed Dec. 23, 2008 and U.S. Provisional Patent Application No. 61/140,140, entitled “LED Projection Display”, filed Dec. 23, 2008, each of which is fully incorporated herein by reference.

### TECHNICAL FIELD

This disclosure regards light emitting diode (“LED”) displays. More particularly, embodiments of systems and methods described herein relate to using shaped substrate LEDs, shaped emitter layer LEDs and LEDs with shaped separate optical devices in displays to generate white light and images.

### BACKGROUND

Current industry practice for construction of LEDs is to use a substrate (typically either single-crystal Sapphire or Silicon Carbide), onto which is deposited layers of materials such as GaN or InGaN. One or more layers (such as, for example, GaN or InGaN) may allow photon generation and current conduction. Typically, a first layer of Gallium Nitride (GaN) is applied to the surface of the substrate to form a transition region from the crystal structure of the substrate to the crystal structure of doped layers allowing for photon generation or current conduction. This is typically followed by an N-doped layer of GaN. The next layer can be an InGaN, AlGaN, AlInGaN or other compound semiconductor material layer that generates photons and that is doped with the needed materials to produce the desired wavelength of light. The next layer is typically a P doped layer of GaN. This structure is further modified by etching and deposition to create metallic sites for electrical connections to the device. During the operation of an LED, as in a traditional diode, extra electrons move from an N-type semiconductor to electron holes in a P-type semiconductor. In an LED, photons are released in the compound semiconductor layer to produce light during this process.

The display industry has multiple display technologies. These technologies are generally divided into two categories: self-emitting (or self-radiating) displays (such as, for example, plasma and organic light emitting diode (OLED) displays) and non-radiating displays requiring an external light source (such as, for example, digital light processing (DLP) displays, liquid crystal on silicon (LCOS) displays and liquid crystal displays (LCDs)). While plasma displays are self-radiating, they are inefficient at converting electrical energy into light and suffer large heat losses. Plasma displays also suffer from low yield as it is difficult to control uniformity over such large areas and exhibit problematic resolution. OLEDs suffer from as-yet unresolved brightness and lifetime issues.

Non-radiating spatial modulators are generally inefficient at directing the light to the display. For example, present DLP and LCOS systems only transmit approximately 1% of the radiated energy from an ultra high performance (UHP) bulb to the screen. LCDs also suffer from yield due to their large extents and they also are not efficient at transmitting generated light to the screen.

### SUMMARY

Embodiments described herein provide various LED displays. According to one embodiment, an LED display can be formed using white light units. Each white light unit can comprise light sources of various colors that can be combined to generate white light. By controlling the intensity of each light source the brightness and color provided by a white light unit can be controlled.

One embodiment of an LED display can comprise an array of white light units with each white light unit comprising a set of color light sources. The color light sources can include one or more red light sources, one or more green light sources and one or more blue light sources. Each color light source can comprise a UV LED and a phosphor layer adapted to down convert UV light from the UV LED into a corresponding color of light. The display can further include a controller electrically coupled to the white light units, the controller configured to control the white light units to alter the color of light produced by the white light units to produce images on the display. According to various embodiments, the UV LED can comprise a rectangular or other typical LED, a shaped substrate LED, a shaped emitter layer LED or an LED used in conjunction with a separate optical device.

According to one embodiment of a display using shaped substrate LEDs, the display can comprise an array of white light units with each white light unit comprising a set of color light sources. The display can further include a controller electrically coupled to the white light units to control the white light units to alter the color of light produced by the white light units to produce images on the display. The set of color light sources can include one or more red light sources, one or more green light sources and one or more blue light sources. Each color light source comprises an LED comprising a set of light emitting layers to generate light and a shaped substrate comprising. The shaped substrate can include an entrance interface to receive light generated in the LED and an exit face. The exit face can have the minimum distance from the entrance interface so that all rays with a direct transmission path from the entrance interface to the exit face are incident on the exit face at less than or equal to the critical angle. The shaped substrate can also include a set of sidewalls shaped to reflect light to the exit face using reflection (e.g., such as using internal reflection or a reflective layer) such that light reflected to the entrance face is incident on the exit face at less than or equal to the critical angle. The size of the exit face and shape of the sidewalls can be selected such that at least 70% of the light entering the substrate through the entrance interface will be extracted through the exit face. According to one embodiment each color light source can include a UV LED used in conjunction with a phosphor layer to produce a desired color of light.

According to another embodiment, an LED display can comprise, a projection optic, a color combiner, an array of red light sources, an array of green light sources, and an array of blue light sources. The array of red light sources, green light sources and blue light sources are configured to provide light to the color combiner in a desired half angle and the color combiner is configured to combine light from the array of red light sources, green light sources and blue light sources into a common plane for transmission to the projection optic.

### BRIEF DESCRIPTION OF THE DRAWINGS

A more complete understanding of the embodiments and the advantages thereof may be acquired by referring to the following description, taken in conjunction with the accompanying drawings in which like reference numbers indicate like features and wherein:

FIG. 1 is a diagrammatic representation of one embodiment of a white light unit;

FIG. 2 is a diagrammatic representation of an embodiment of overlapping white light units;

FIG. 3a is a diagrammatic representation of one embodiment of an LED with a shaped substrate and FIG. 3b is a diagrammatic representation of one embodiment of a shaped substrate;

FIGS. 4-5 are diagrammatic representations of embodiments of packaged LEDs;

FIG. 6 is a diagrammatic representation of one embodiment of a shaped emitting layer LED;

FIG. 7a is a diagrammatic representation of an embodiment of an LED and separate optical device and FIG. 7b is a diagrammatic representation of an embodiment of a separate optical device;

FIG. 8 is a diagrammatic representation of one embodiment of a separate optical device and LED;

FIG. 9 is a diagrammatic representation of one embodiment of a display;

FIG. 10 is a diagrammatic representation of another embodiment of a display; and

FIG. 11 is a diagrammatic representation of another embodiment of a display.

### DETAILED DESCRIPTION

Embodiments and various features and advantageous details thereof are explained more fully with reference to the exemplary, and therefore non-limiting, examples illustrated in the accompanying drawings and detailed in the following description. Descriptions of known starting materials and processes may be omitted so as not to unnecessarily obscure the disclosure in detail. It should be understood, however, that the detailed description and the specific examples, while indicating the preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like.

Reference is now made in detail to the exemplary embodiments of the disclosure, examples of which are illustrated in the accompanying drawings. Wherever possible, like numerals will be used throughout the drawings to refer to like and corresponding parts (elements) of the various drawings.

One method of generating white light involves the use of red, green and blue LEDs in combination with one another. A lighting source that is made of combinations of red, green and blue LEDs will produce what is perceived as white light by the human eye. This occurs because the human eye has three types of color receptors, with each type sensitive to either blue, green or red colors. A second method of producing white light from LED sources is to create light from a single-color (for example, blue), short wavelength LED, and impinge a portion of that light onto a phosphor or similar photon conversion material. The phosphor absorbs the higher energy, short wavelength light waves, and re-emits lower energy, longer wavelength light. If a phosphor is chosen that emits light in the yellow region (between green and red), for example, the human eye perceives such light as white light. This occurs because the yellow light stimulates both the red and green receptors in the eye. White light may also be generated utilizing an ultraviolet (UV) LED and using red, green and blue phosphors that down convert the UV light to the desired color. The red, green and blue light can be combined to form white light. White light may also be generated from a combination of blue LED and a yellow LED, a combination of blue, green, yellow and red LEDs or other combinations of LEDs.

Embodiments described herein provide LED based displays utilizing various types of LEDs to create white light units. According to one embodiment, the LED based displays use shaped substrate LEDs, such as the shaped substrate LEDs described in U.S. Provisional Patent Application No. 60/827,818, entitled “SHAPED LIGHT EMITTING DIODES”, to Duong et al., filed Oct. 2, 2006, U.S. Provisional Patent Application No. 60/881,785, entitled “SYSTEM AND METHOD FOR A SHAPED SUBSTRATE LED”, to Duong et al., filed Jan. 22, 2007, U.S. patent application Ser. No. 11/906,194 entitled “LED System and Method” to Duong, et al. filed Oct. 1, 2007, and U.S. patent application Ser. No. 11/906,219 entitled “LED System and Method” to Duong, et al., filed Oct. 1, 2007, each of which is fully incorporated by reference herein. Other embodiments can use LEDs having shaped light emitting layers as described in U.S. Provisional Patent Application No. 60/027,354 entitled “Emitter Layer Shaping” to Duong et al., filed Feb. 8, 2008, U.S. Provisional Patent Application No. 61/049,964 entitled “Emitter Layer Shaping,” to Duong et al. filed Nov. 25, 2008 and U.S. patent application Ser. No. 12/367,343 entitled “System and Method for Emitter Layer Shaping” filed Feb. 6, 2009, each of which is hereby fully incorporated by reference herein. Yet other embodiments can utilize LEDs with separate optical devices as described in United Sates, Provisional Patent Application No. 60/756,845, entitled “Optical Device”, to Duong et al., filed Jan. 5, 2006 and U.S. patent application Ser. No. 11/649,018 entitled “Separate Optical Device for Directing Light from an LED,” filed Jan. 3, 2007, each of which is hereby fully incorporated by reference herein.

Embodiments described herein can maximize light output for a given power input, a quantity often expressed in lumens per watt (lm/W) for white light and longer wavelength light, or milliwatts per watt (mW/W) for shorter wavelength light such as blue. This ratio is typically referred to as “overall efficiency” or “wall-plug efficiency.” Because shaped substrate and shaped emitter layer LEDs have greater extraction efficiency from the LED and separate optical devices as described in the applications listed above have greater extraction efficiency than traditional optical device systems, embodiments described herein utilizing such LEDs can provide better overall efficiency.

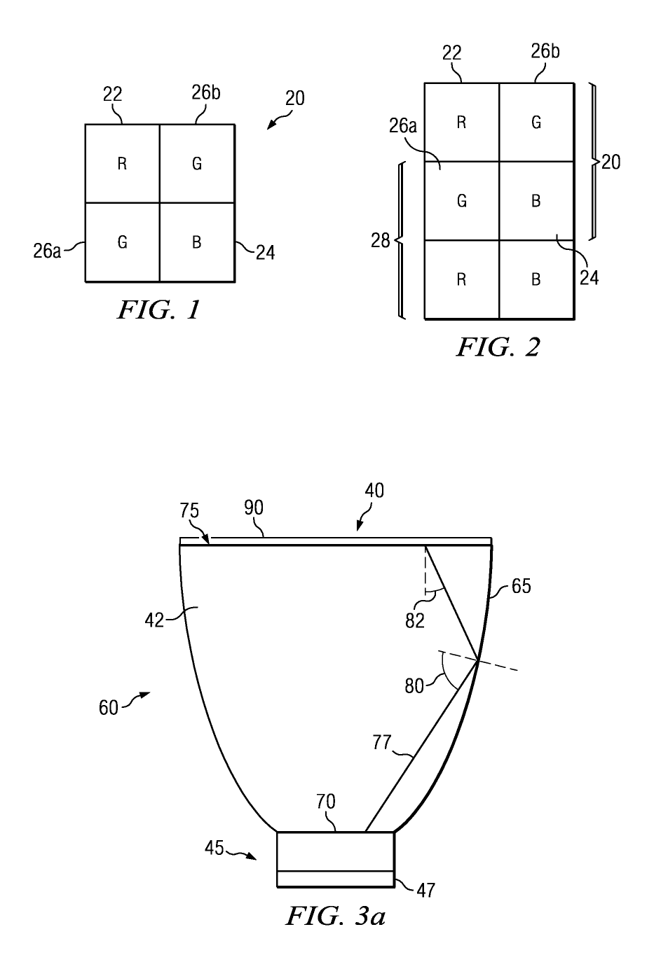

Embodiments described herein can utilize arrays of LEDs to create color displays. According to one embodiment, LEDs can be arranged such that the light from the LEDs combines to create white or other desired color light. FIG. 1 is a diagrammatic representation of an embodiment of a white light unit 20 comprising Red (R), Blue (B) and Green (G) light color sources. The number and pattern of R, G and B color light sources in white light unit 20 can vary. The color light sources can comprise LEDs designed to emit a desired color of light or LEDs that are used in conjunction with phosphors or other materials to emit a desired color of light. In the example of FIG. 1, white light unit 20 comprises Red color light source 22, Blue color light source 24 and Green color light sources 26a and 26b.

Multiple white light units 20 can be combined to form a display or to provide light in a display (such as an LCD display). Each white light unit 20, according to one embodiment, can function as a pixel or portion of a pixel in a display. In some embodiments, the pattern of LEDs can be set out such that white light units overlap. FIG. 2, for example, illustrates white light unit 20 and white light unit 28 sharing green color light sources 26a and 26b.

The color or colors displayed by a white light unit or white light units in a display can be varied over time by varying the brightness of the constituent color light sources of one or more white light units. In one embodiment, the current to the color light sources of the white light units can be varied to change the brightness. For example, the duty cycle of the current supplied to the individual LEDs may be varied over time. By varying the color of multiple white light units an image can be displayed. This image can be varied over time based on inputs to cause the display to show moving images such as movies, advertisements or other image.

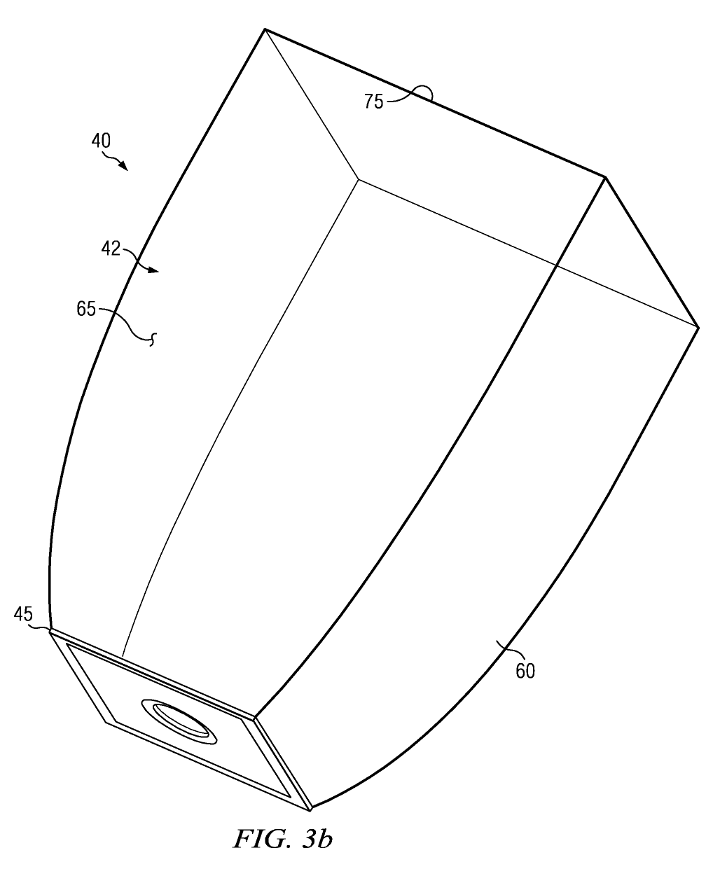

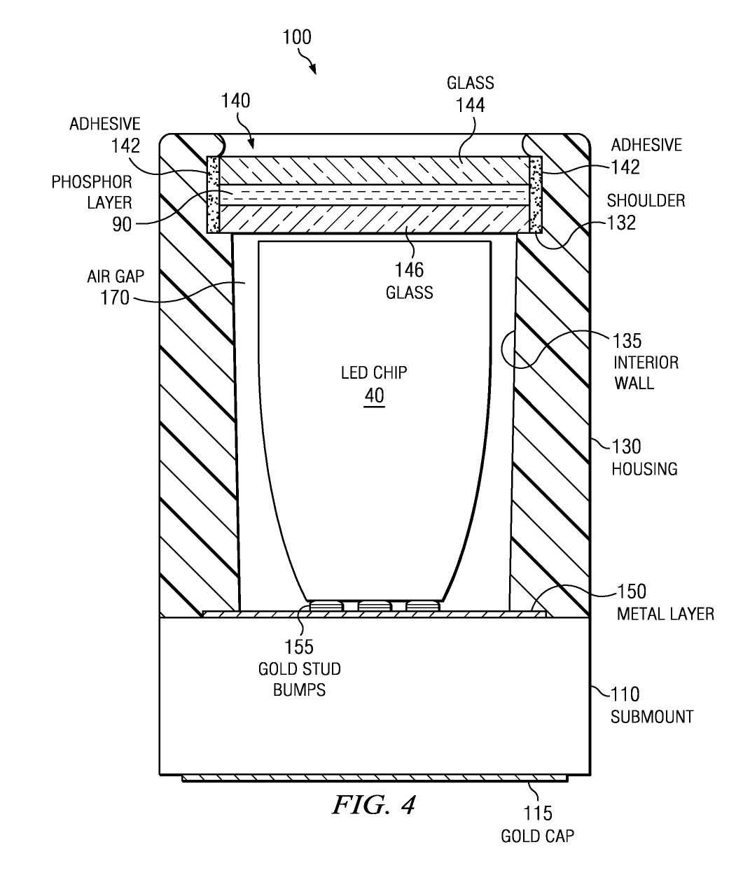

FIG. 3-8 illustrate various example embodiments of color light sources using LEDs that can be used in forming white light units. The embodiments of FIGS. 3-8 are provided by way of example and other suitable LEDs can be used.

FIG. 3a is a diagrammatic representation of one embodiment of an LED 40 for emitting light of a selected color. FIG. 3b is a diagrammatic representation of a perspective view of an embodiment of a rectangular LED 40 illustrating substrate 42, quantum well region 45, exit face 75 and sidewalls 60 and 65. According to the embodiment of FIGS. 3a and 3b, LED 40 is a shaped substrate LED. LED 40 can be a flip chip or other LED known or developed in the art. Referring to FIG. 3a, LED 40 can include a substrate 42 and non-substrate layers 45 referred to herein as “quantum well region 45” that may comprise one or more layers or regions of doping, buffer layers or other layers. Quantum well region 45 includes a light emitting region 47, typically a compound semiconductor such as InGaN or AlInGaP or AlGaN. Photons from quantum well region 45 may enter substrate 42 through interface 70. LED 40 further includes exit face 75 that may be substantially the same shape as, substantially parallel to and substantially rotationally aligned with interface 70 within the tolerance of the manufacturing process. In various embodiments, exit face 75 can be rectangular (including square), circular, hexagonal or have another desired shape.

The area of exit face 75 can be chosen to conserve brightness for a desired half angle according to conservation of radiance. According to one embodiment, the area of exit face 75 can be within a selected range of the minimum area necessary to conserve radiance of light entering interface 70, such as plus or minus 30% of the minimum area to conserve radiance. Preferably, the exit face 75 is within plus or minus 5% of the minimum area necessary to conserve radiance and even more preferably within the manufacturing tolerance of the minimum area.

The height of substrate 42 can be selected to limit the critical angle of rays incident on exit face 75 to a range between normal to exit face 75 to the critical angle at exit face 75. The height can be selected so that all rays having a direct transmission path from interface 70 to exit face 75 are incident on exit face 75 at less than or equal to the critical angle. In other embodiments, the height of substrate 42 is selected to be within plus or minus 30% of this height and preferably within plus or minus 5% of this height and even more preferably within the manufacturing tolerance of this height.

The sidewalls 60 and 65 can be shaped to direct light incident on the sidewalls to exit face 75 such that the light is incident on exit face 75 to produce a desired light output profile (e.g., intensity profile, exitance profile or other light output profile) at an angle equal to or less than the critical angle. While for most applications the desired intensity profile is uniform or close to uniform, other distribution profiles can be achieved by varying the height and shapes of the sidewalls. Quantum well region 45 can be shaped in conformance with substrate 42. For example, both substrate 42 and quantum well region 45 form sidewall 60, sidewall 65 or other sidewalls. In other embodiments, only the sidewalls of substrate 42 are shaped.

Broadly speaking, the sidewalls are shaped so that any ray incident on a sidewall is reflected to exit face 75 and is incident on exit face 75 at the critical angle or less (i.e., so that there is no loss due to internal reflection at exit face 75). Preferably, the sidewalls are also shaped so that a ray viewed in a cross-sectional view only hits a side wall once. However, there may be additional reflection from a sidewall out of plane of the section. For a full 3D analysis, a ray that strikes a first sidewall near a corner, may then bounce over to a second side wall, adjacent to the first, and from there to the exit face. The sidewalls can be faceted or curved to achieve the desired reflection. FIG. 3a illustrates, for example, that ray 77 is incident on sidewall 65 at an angle 80 such that ray 77 reflects to exit face 75. Ray 77 is incident on exit face 75 at equal to less than the critical angle 82.

While, in one embodiment, the sidewalls are shaped so that all rays that encounter the inner surface of the sidewalls experience total internal reflection to exit face 75 and are incident on exit face 75 at the critical angle or less, other sidewall shapes that allow some loss can be used. Preferably, a majority of rays incident on the sidewalls reflect to the exit face 75 in a manner that prevents total internal reflection (“TIR”) at exit face 75. According to one embodiment, LED 40 can be shaped such that at least 70% of the light entering substrate 42 at interface 70 exits exit face 75. According to other embodiments, through sidewall shaping and selecting the size of the exit face, the substrate 42 can have the minimum size necessary to conserve radiance and to extract approximately all the light from the substrate not including Fresnel losses. Antireflective or other coatings can be used to reduce Fresnel losses.

A layer 90 of phosphor can be deposited on exit face 75. According to one embodiment, phosphor layer 90 can include a layer of phosphor particles in a binding material, such as silicone, applied to the exit face 75 of LED 40. In other embodiments, layer 75 may be integrated into a packaging design. For example, phosphor layer 90 can be applied to a glass layer or other layer of material offset from the exit face 75 of LED 40 as described, for example, in U.S. Provisional Patent Application No. 61/121,875, entitled “Systems and Methods for Packaging Light-Emitting Diode Devices”, filed Dec. 11, 2008, which is hereby fully incorporated by reference herein. Layer of phosphor 90 can include phosphor particles selected to down-convert light generated by LED 40 to a selected color. The phosphor particles can include any suitably sized phosphor particles including, but not limited to, nano-phosphor particles, quantum dots, or smaller or larger particles.

FIG. 4 is a diagrammatic representation of a cross-sectional view of a packaged LED 100 having LED 40 packaged in a housing 130. In the embodiment of FIG. 4, the phosphor layer 90 is held away from LED 40. Housing 130, according to one embodiment, may have a shoulder area 132 on top of interior wall 135, near the top opening of housing 130. Shoulder area 135 may wrap around on top of interior wall 135 inside housing 130 or may only be present at the top of particular walls.

A phosphor plate 140 can be positioned above LED 40 inside housing 130. In addition to offering environmental protection for LED chip 40, housing 130 may also provide mechanical support for phosphor plate 140. According to one embodiment, phosphor plate 140 may comprise phosphor layer 90 sandwiched between glass 144 and glass 146. Other optically transparent materials such as clear polymer may also be used to sandwich or carry phosphor layer 90.

Phosphor plate 140 may be secured to housing 130 using adhesive 142. Adhesive 142 may be a thermo epoxy resin or other synthetic resin with desired thermal and adhesive properties. In some embodiments, the thermo epoxy resin can withstand reflow temperatures above 260° C. LED 40 and phosphor plate 140 can separated by air gap 170. In some embodiments, air gap 170 comprises the space between interior wall 135 and LED chip 120. Air gap 170 may be minimized by manipulating the shape of interior wall 135.

Housing 130 can be made of a plastic material that can withstand reflow temperatures. In some embodiments, the housing is made of a Liquid Crystal Polymer (LCP) or other suitable polymeric or composite material that allows it to withstand high temperatures.

LED 40 can be mounted to a submount 110 that can be made of a material with high thermal conductivity to spread and conduct the heat produced by LED chip 40. The size of supporting submount 110 for a LED 40 can be minimized depending on the housing requirement. In some embodiments, the submount may be about 1 mm or less. With packaging improvements, further reduction may be possible. Embodiments of submount materials include, but are not limited to: Low Temperature Cofire Ceramic (LTCC) with thermal vias, High Temperature Cofire Ceramic (HTCC) with thermal vias, Beryllium Oxide (BeO) ceramic, Alumina ceramic, Silicon, Aluminum Nitride (AlN), Metal (Cu, Al, etc.), and Flex circuit. Submount 110 provides support for metal layers 150 to provide electrical traces for LED 40. The submount may further comprise gold caps 115 on the bottom surface and embedded vias connecting the gold caps 115 on the bottom surface and the metal traces 150 on the top surface. In some embodiments, the Gold-to-Gold Interconnect (GGI) process may be used to attach LED chip 40 to submount 110. The advantage of using the GGI process is the high thermal conductivity of gold stud bumps 155. In some embodiments, solder-based approaches may be used to attach LED chip 120 to submount 110. It should be noted, however, that the submount is provided way of example and any suitable submount for providing mechanical support and electrical connectivity can be used.

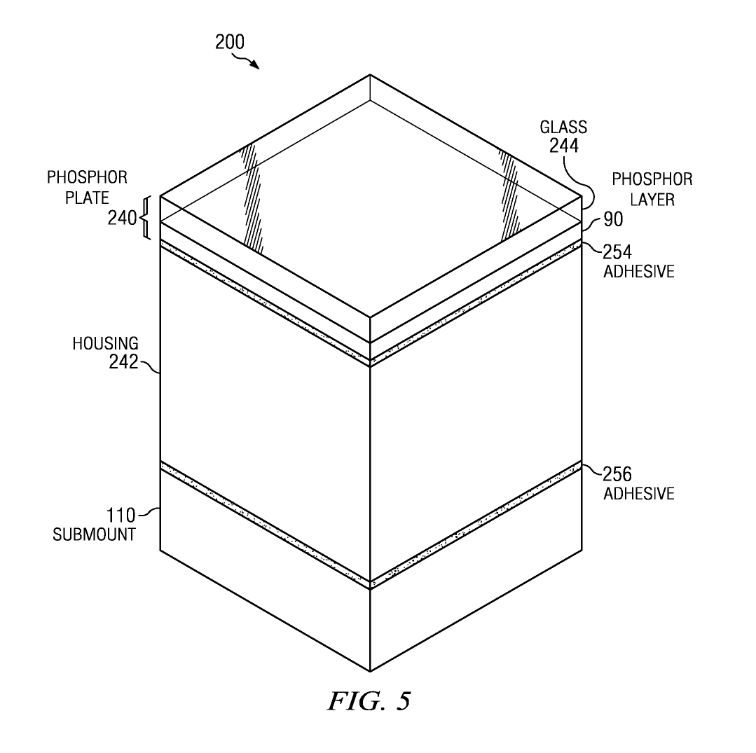

FIG. 5 is a diagrammatic representation of a perspective view of an example of another embodiment of packaged LED 200 having submount 110, housing 242, and phosphor plate 240. In this example, phosphor plate 240 may be attached to housing 230 utilizing adhesive 254 and housing 230 may be attached to supporting submount 110 utilizing adhesive 256. Adhesive 254 and adhesive 256 may be the same or different. Phosphor plate 240 may comprise phosphor layer 90 and glass 244. In some embodiments, phosphor layer 90 may be created by depositing phosphor on top of glass 244, acrylic or other optically transparent material in a separate process prior to attaching phosphor plate 240 to housing 242. Phosphor layer 90 may be deposited on the top or the bottom of a layer of material or sandwiched layers to create phosphor plate 240.

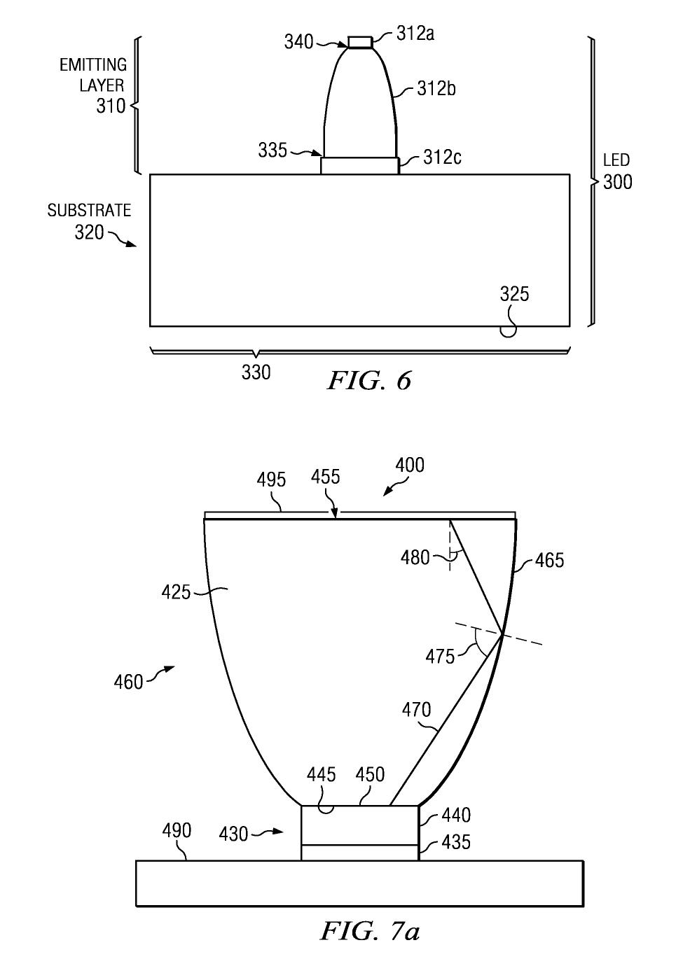

FIG. 6 is a diagrammatic representation of another embodiment of an LED 300 that can be used in conjunction with red, green or blue phosphors or nanoparticles. LED 300 comprises light emitting layers (e.g., quantum well layers), buffer layers and other layers (illustrated at emitting layers 310) and substrate 320. According one embodiment, emitting layers 310 can include a light emitting region 312a, shaped, a shaped region 312b and an unshaped region. Light or energy generated in quantum well region emitting region 312a traverses emitting layers 310 and enters substrate 320 and to exits LED 300 at exit face 325. Red, green, blue or other color phosphors 330 may be deposited on exit face 325. The light generated can excite the phosphors on exit face 325. The excitation of the phosphors causes the phosphors to emit light visible to the human eye.

In general, the shaped portion of layers 310 can be shaped so that the exit plane of the shaped portion, represented at 335, has the minimum size necessary to conserve radiance given the area of the light emitting region. For example, exit interface 335 can be sized relative to the area of region 312a (represented by interface 340). According to one embodiment, the area of plane 335 can be within a selected range of the minimum area necessary to conserve radiance, such as plus or minus 30% of the minimum area to conserve radiance. Preferably, the exit plane 335 is within plus or minus 5% of the minimum area necessary to conserve radiance and even more preferably within the manufacturing tolerance of the minimum area. The height of shaped region 312b can be selected so that rays having a direct transmission path from interface 340 to plane 335 are incident on plane 335 at less than or equal to the critical angle between the emitter layers 310 and the substrate 320. In other embodiments, the height of shaped region 312b is selected to be within plus or minus 30% of this height and preferably within plus or minus 5% of this height and even more preferably within the manufacturing tolerance of this height.

The sidewalls of shaped region 312b can be shaped so that light incident on a sidewall is reflected to exit plane 355 and is incident on exit plane 355 at the critical angle or less (i.e., so that there is no loss due to internal reflection at exit face 325). Preferably, the sidewalls are also shaped so that a ray viewed in a cross-sectional view only hits a side wall once. However, there may be additional reflection from a sidewall out of plane of the section. For a full 3D analysis, a ray that strikes a first sidewall near a corner, may then bounce over to a second side wall, adjacent to the first, and from there to the exit face. The sidewalls can be faceted or curved to achieve the desired reflection.

While, in one embodiment, the sidewalls are shaped so that all rays that encounter the inner surface of the sidewalls experience total internal reflection to exit plane 335 and are incident on exit face 325 at the critical angle or less, other sidewall shapes that allow some loss can be used. Preferably, a majority of rays incident on the sidewalls reflect to the exit face 335 in a manner that prevents TIR at exit face 325. According to one embodiment, LED 300 can be shaped such that at least 70% of the light generated in emitter layers 310 exits exit face 325. According to other embodiments, LED 300 can have the minimum size necessary to conserve radiance and to extract approximately all the light from generated, not including Fresnel losses.

It should be noted that in other embodiment, exit plane 335 can be the interface with substrate 320 such that there is not an unshaped region 312c. LED 300 can have a variety of shapes including, but not limited to, rectangular (including square), hexagonal, round or other desired shape. Phosphor layer 330 can be maintained some distance away from exit face 325 (e.g., by packaging or other mechanism), or LED 300 can be configured to emit a particular color light without a phosphor layer.

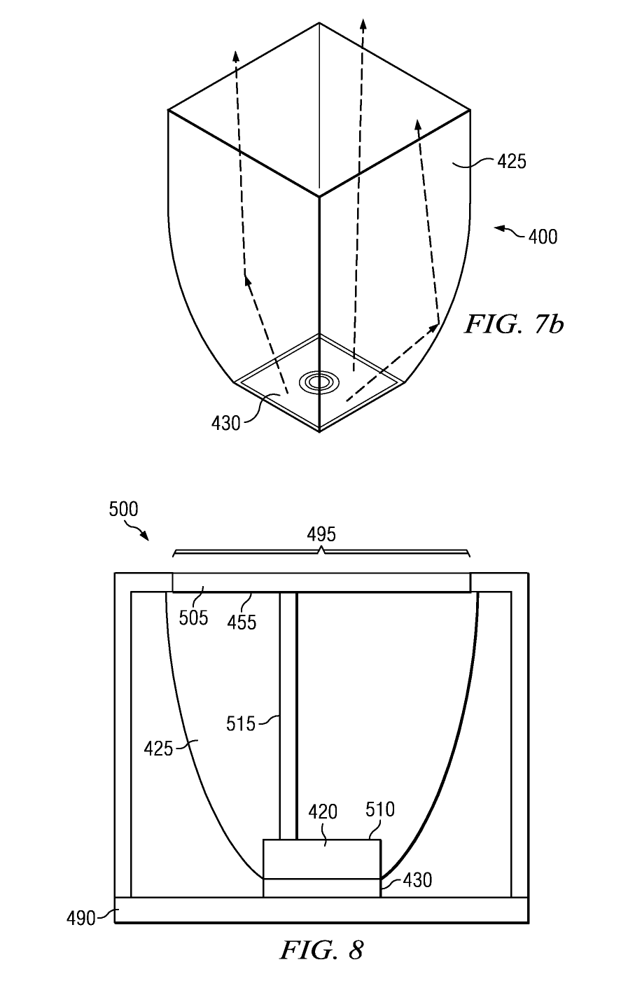

FIG. 7a is a diagrammatic representation of one embodiment of an optical system 400 including a separate optical device 425 and an LED 430. While a single LED 430 is illustrated, multiple LEDs can be used with a single separate optical device 425. FIG. 7b is a perspective view of one embodiment of one embodiment of system 400. With reference to FIGS. 7a and 7b, LED 430 can be a wire bond, flip chip or other LED known or developed in the art. LED 430, according to one embodiment, includes light emitting layers (e.g., quantum well layers), buffer layers and other layers (illustrated as quantum well region 435) and substrate 440. In FIG. 7a the substrate 440 is positioned as typically embodied, above the light emitting portion; in another typical design, the substrate 440 may be positioned below the light emitting portion. Light from LED 430 is primarily transmitted through emitting surface 445 to separate optical device 425. FIG. 7a depicts the separate optical device affixed to the primary exit face of LED 430. Alternatively, it may fully or partially surround the LED 430 on the sides as well as on emitting surface 445.

Separate optical device 425 is can be coupled to LED 430 using a friction fit, optical cement or other coupling mechanism, whether mechanical, chemical, or other. Preferably, separate optical device 425 is formed of a single, molded piece of dielectric, optically transmitting material with a single Index of Refraction (“IOR”) “n”, such as optically transparent silicone or acrylic, though other materials can be used. Furthermore, the IOR of separate optical device 125 is preferably within 20% of the IOR of substrate 440 (and ideally, the IOR of separate optical device 425 is equal to or greater than IOR of substrate 440).

Separate optical device 425 includes an entrance surface 450 to receive light transmitted from LED 430. Entrance surface 450, according to one embodiment, is the same shape as surface 445 and has an edge dimension approximately the same size as or slightly larger than the edge dimension of emitting surface 445.

Separate optical device 425 further includes exit face 455 that preferably is substantially the same shape as, substantially parallel to and substantially rotationally aligned with entrance surface 450 within the tolerance of the manufacturing process. The area of exit face 455 can be chosen to conserve brightness for a desired half angle according to conservation of radiance. According to one embodiment, the area of exit face 455 can be within a selected range of the minimum area necessary to conserve radiance, such as plus or minus 30% of the minimum area to conserve radiance. Preferably, the exit face 455 is within plus or minus 5% of the minimum area necessary to conserve radiance and even more preferably within the manufacturing tolerance of the minimum area.

The distance between entrance surface 450 and exit face 455 of separate optical device 425 may be selected to reduce or minimize TIR of light rays traveling directly from entrance surface 450 to exit surface 455. The height can be selected so that all rays having a direct transmission path from entrance face 450 to exit face 455 are incident on exit face 455 at less than or equal to the critical angle. In other embodiments, the height of separate optical device 425 is selected to be within plus or minus 30% of this height and preferably within plus or minus 5% of this height and even more preferably within the manufacturing tolerance of this height.

The sidewalls 460, 465 and other sidewalls can be shaped to direct light incident on the sidewalls to exit face 455 such that the light will not experience TIR at exit face 455 and will be incident on exit face 455 to produce a desired light output profile (e.g., intensity profile, exitance profile or other light output profile). While for most applications the desired intensity profile is uniform or close to uniform, other distribution profiles can be achieved by varying the height and shapes of the sidewalls.

The sidewalls can be shaped so that any ray incident on a sidewall is reflected to exit face 455 and is incident on exit face 455 at the critical angle or less (i.e., so that there is no loss due to internal reflection at exit face 455). Preferably, the sidewalls are also shaped so that a ray viewed in a cross-sectional view only hits a side wall once. However, there may be additional reflection from a sidewall out of plane of the section. For a full 3D analysis, a ray that strikes a first sidewall near a corner, may then bounce over to a second side wall, adjacent to the first, and from there to the exit face. The sidewalls can be faceted or curved to achieve the desired reflection.

While, in one embodiment, the sidewalls are shaped so that all rays that encounter the inner surface of the sidewalls experience total internal reflection to exit face 455 and are incident on exit face 455 at the critical angle or less, other sidewall shapes that allow some loss can be used. Preferably, a majority of rays incident on the sidewalls reflect to the exit face 455 in a manner that prevents TIR at exit face 455. According to one embodiment, separate optical device 425 can be shaped such that at least 70% of the light entering separate optical device 425 at interface 450 exits exit face 455. According to one embodiment, separate optical device 125 can be shaped to have the minimum size necessary to conserve radiance and to extract all the light from the exit face not including light lost due to Fresnel losses.

According to one embodiment, the sidewalls are shaped so that any ray incident on a sidewall is reflected to exit face 455 and is incident on exit face 455 at the critical angle or less (i.e., so that there is no loss due to internal reflection at exit face 455). Preferably, the sidewalls are also shaped so that a ray viewed in a cross-sectional view only hits a side wall once. However, there may be additional reflection from a sidewall out of plane of the section. For a full 3D analysis, a ray that strikes a first sidewall near a corner, may then bounce over to a second side wall, adjacent to the first, and from there to the exit face. The sidewalls can be faceted or curved to achieve the desired reflection. FIG. 7a illustrates, for example, that ray 470 incident on sidewall 465 at an angle 475 such that ray 470 reflects to exit face 455. Ray 470 is incident on exit face 455 at equal to less than the critical angle 480.

While, in one embodiment, the sidewalls are shaped so that all rays that encounter the inner surface of the sidewalls experience total internal reflection to exit face 455 and are incident on exit face 455 at the critical angle or less, other sidewall shapes that allow some loss can be used. Preferably, a majority of rays incident on the sidewalls reflect to the exit face 455 in a manner that prevents TIR at exit face 455. According to one embodiment, separate optical device 425 can be shaped such that at least 70% of the light entering separate optical device 425 at interface 450 exits exit face 455. According to other embodiments, the separate optical device 425 can have the minimum size necessary to conserve radiance and to extract approximately all the light from the separate optical device not including Fresnel losses. According to one embodiment, antireflective or other coatings can be used to reduce Fresnel losses.

LED 430 can be mounted to a submount 490 that can provide mechanical support, electrical connections and thermal conductivity as discussed above. LED 430 can be selected to emit a desired color light or a phosphor layer 495 can be applied to exit face 455 to down convert light to the desired color.

FIG. 8 is a diagrammatic representation of one embodiment of adding phosphor to an optical device. FIG. 8 also illustrates that separate optical device 425 can surround LED 430 on the sides. According to one embodiment, as illustrated in FIG. 8, an attachment device 500 can be used to secure separate optical device 425 to submount 490, a circuit board or another structure. According to one embodiment, separate optical device 425 and attachment device 500 can be formed of a single piece of molded material. According to another embodiment, separate optical device 425 and attachment device 430 can be separate devices. If attachment device 500 and separate optical device 425 are separate, they can include interlocking locating features such as bumps or ridges for more secure and accurate alignment of the devices. According to one embodiment, attachment device 500 can support a phosphor plate 505 that includes a phosphor layer 495 to down convert light to a desired color. Phosphor plate 505 can comprise a glass or other optically transparent plate coated with a layer of phosphor 495. The phosphor layer can be coated on the top or bottom of the transparent material and, in one embodiment, can be sandwiched between plates of transparent material. Phosphor plate 505 can be in contact with or be separated from exit face 455 by an air gap.

In another embodiment, LED 430 can be coated with phosphor particles 510 between LED 430 and separate optical device 425. A passage 515 can be used to introduce phosphor layer 495 and optical adhesive between separate optical device 425 and LED 430. In another embodiment, phosphor layer 510 can be applied prior to coupling separate optical device 425 to LED 430.

The foregoing examples of LEDs are provided by way of example and not limitation. Any suitable LED can be used in a white light array, including LEDs that generate white or other color light. The LEDs can be round, square, hexagonal or have any other desired shape.

Returning briefly to FIG. 1, each color light source in white light unit 20 can include an LED that generates Ultraviolet (“UV”) light. Phosphor particles can down convert the UV light to the appropriate color. Because UV light is outside of the spectrum visible by a human eye, the human eye will only see the light emitted by the phosphors. The use of a UV or other LED in conjunction with phosphors allows LEDs grown on or from a common substrate to be used to emit different colors of light. For example, LEDs from a common substrate may have phosphors applied to the exit faces of the LEDs such that one or more LED emits red light, one or more emit green light, and one or more emit blue light and together these LEDs make up one or more white light units. In other embodiments, the LEDs may emit red, green and blue light without the use of phosphors.

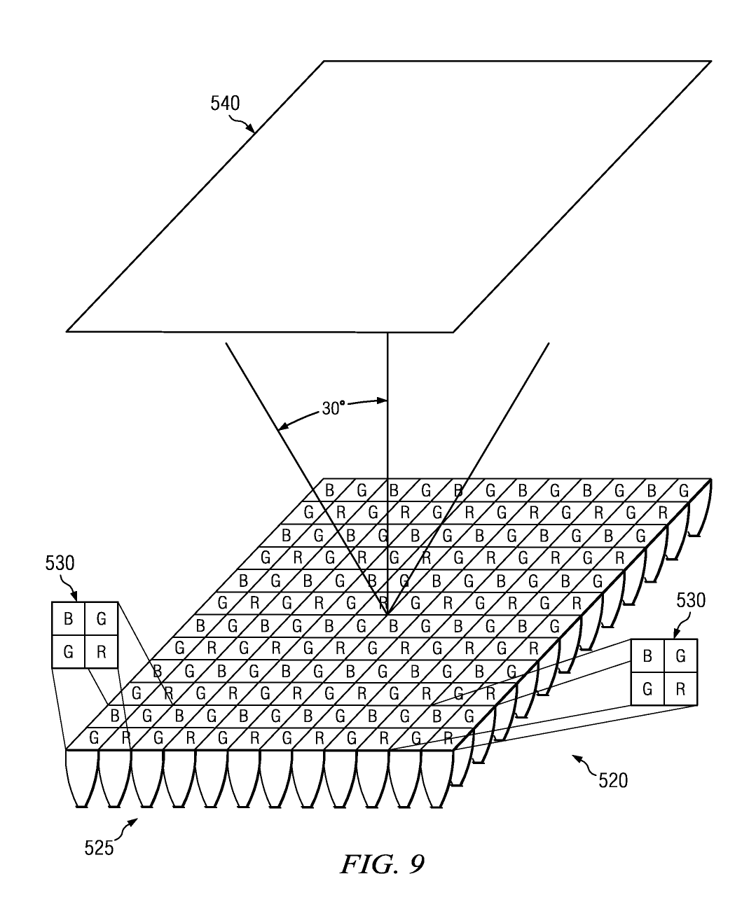

FIG. 9 is a diagrammatic representation of a display 520 comprising an array 525 of shaped substrate LED, shaped emitter layer LEDs or LEDs with a separate optical device. The multiple LEDs of display 520 may have phosphors excitable to generate red, green or blue light when energy or light is applied to them. For example, each LED may have a corresponding coating of a colored phosphor applied to the exit face such that combinations of the LEDs of display 520 form white light units 530.

Using shaped substrate LEDs in display 520 can allow LEDs to be grown from a common substrate and shaped to form the multiple shaped substrate LEDs of display 520. Utilizing one or more LEDs having shaped quantum well regions, on the other hand, may be advantageous because more light may be extracted from individual LEDs, increasing the overall light emitted from the display. Furthermore, the use of shaped emitter layer LEDs in the display may reduce the amount of power required by the display and because shaping the emitter layer may allow for control of the direction of light emitted from an LED, finer resolution may be achieved. In addition, shaping the emitter layer of LEDs of a display may enable the use of a common substrate for multiple LEDs.

In one embodiment, the shaped substrate LEDs may be shaped so as to direct the lambertian source of the light or energy emitting layers into a light emission angle congruent with a collection angle of various projection optics or otherwise appropriate for a display. For example, shaped substrate LEDs utilized in a display may be shaped so as to emit light with a desired half-angle which is appropriate for viewing of a particular display. A display can comprise shaped substrate LEDs having different shapes and different half-angles arranged to maximize the performance, resolution or picture quality of the display depending upon the application.

According to one embodiment, shaped substrate LEDs of array 525 may be shaped to emit light with a half angle congruent with the collection angle of projection lens 540. As shown in this embodiment, such a congruent half angle may be 30°. In other embodiments, the half angle can be any desired half angle. Using shaped substrate LEDs ensures that all or approximately all of the light or energy generated by the LEDs is directed toward the phosphor or other light emitters and all or approximately all of the energy is directed to the screen such that maximal light is presented to a viewer. This makes the display very efficient. Applications such as mini-projectors are ideal for these highly efficient systems.

If shaped emitter layer LEDs are used, the of shaped emitter layer LEDs may be shaped so as to direct emitted light into a light emission angle congruent with a collection angle of various projection optics or otherwise appropriate for a display. For example, the shaped emitter layer LEDs utilized in a display may be shaped so as to emit light with a desired half-angle which is appropriate for display viewing of a particular display. Shaped emitter layer LEDs may have different emitter layer shapes and different half-angles and these LEDs may be arranged to maximize the performance, resolution or picture quality of the display depending upon the application.

The high light-extraction of shaped emitter layer LEDs makes the use of shaped emitter layer LEDs conducive to highly efficient systems. In one application, the display can be a microdisplay that can be directly viewed. Such devices may be useful for use in visors, heads up displays or other small displays. The display and the shape of the shaped substrate LEDs comprising the display can be optimized to the particular application.

If separate optical devices are used, the separate optical devices may be shaped so as to achieve a desired half-angle. Separate optical devices allow standard LEDs to be utilized without requiring that phosphors be applied directly to the LED. This may reduce or prevent the breakdown of phosphors which may be caused by heat energy discharged by the LEDs. A display can comprise LEDs with separate optical devices having different shapes and different half-angles arranged to maximize the performance, resolution or picture quality of the display depending upon the application.

Another application is to create a large display using shaped substrate LEDs, shaped emitter layer LEDs or separate optical devices. In embodiments of such applications, it may be desired to shape the LEDs or separate optical devices such that the emission angle may be as high as a 90 degree half angle for viewing from any angle. It may be similarly desirable to shape the emitter layers of a shaped emitter layer LED such that the emission angle of light is a desired half-angle.

Displays as described herein may be directly viewed or viewed through a projection lens or other interface without the need for polarizers or other intermediate optics which may cause energy or light losses. Thus, embodiments of systems and methods described above may result in displays which are more energy efficient than prior art displays. The displays may also be brighter, longer lived and have greater yield than prior art display technologies. In other embodiments, LEDs white light units can be arranged to provide back or side lighting for LCD or other displays.

In one embodiment, arrays of LEDs which emit blue, green or red light can be used in conjunction with projection optics and a color combining device, such as one or more dichroic filters, a prism or other mechanism for combining red, green and blue light generated by the shaped LED arrays, to form a display. The arrays of LEDs can generate red, green and blue light which is combined by the color combining prism and radiated to projection optics that present colors or images. The LEDs can generate the desired color light without the use of a phosphor layer or can generate light that is down converted by a phosphor layer to the desired color. The LEDs can be shaped substrate, shaped emitter layer or other LED. The LED array can also comprise LEDs used in conjunction with separate optical devices.

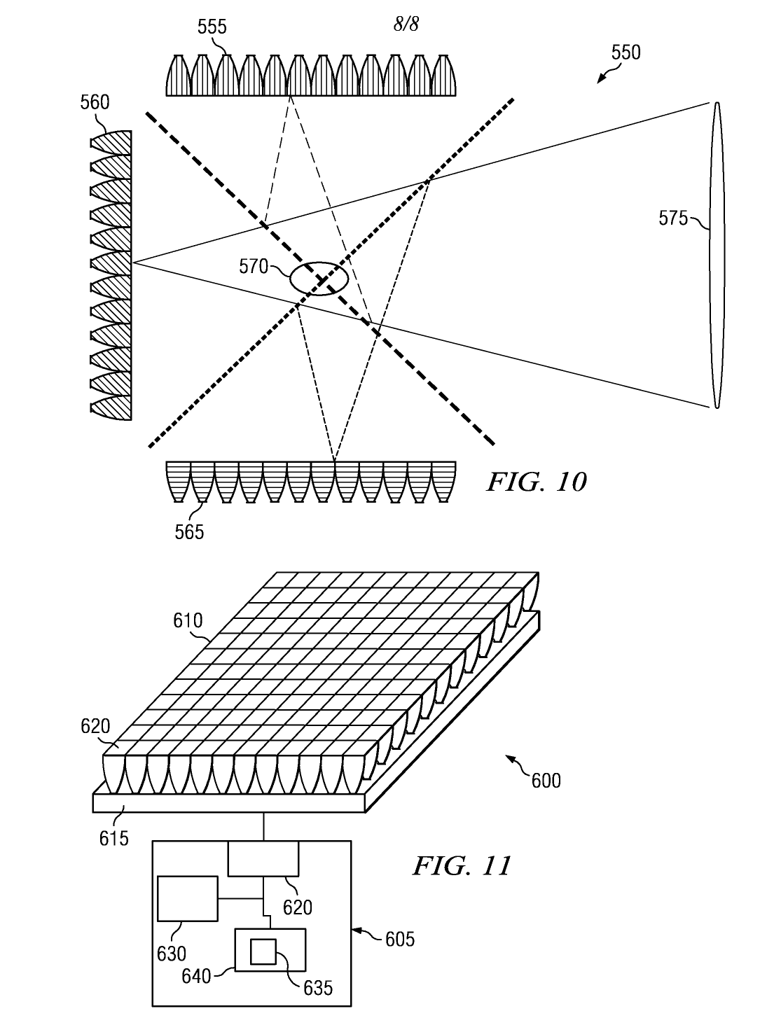

FIG. 10 is a diagrammatic representation of one embodiment of an LED projection display 550. LED projection display 550 comprises red LED array 555, green LED array 560 and blue LED array 565. According to one embodiment, red LED array 555, green LED array 560 and blue LED array 565 comprise shaped substrate LEDs, shaped emitter layer LEDs, LEDs with separate optical devices or other LEDs configured to emit light with a desired half angle.

LED projection display 550 further comprises color combining device 570 which combines light received from red LED array 555, green LED array 560 and blue LED array 565 into a common plane for transmission to projection optics 575. Color combining device 570 can include one or more diachroic filters, a prism or other mechanism for combining red, green and blue light generated by the LED arrays. Projection optics 575 may be used to present images directly to a viewer or to a device that presents the images to a viewer.

To generate the desired images or light at the object plane of the projection optics 575, the current to individual LEDs may be varied. For example, the duty cycle of current to individual LEDs may be varied over time (for example, pulse-width modulated). In one embodiment, a controller may control the current to the individual LEDs according to one or more computer programs or algorithms to create an image with regard to projection optics 575. This image may be varied over time based on inputs to cause projection optics 575 to display moving images (such as, for example, movies, advertisements or other image that may be displayed).

In one embodiment, shaped substrate LEDs may be shaped so as to direct the lambertian source of the light or energy emitting layers into a light emission angle congruent with the acceptable angle of the color combining device and/or congruent with a collection angle of the projection optics. For example, the shaped substrate LEDs may be shaped so as to emit light with a desired half-angle which is appropriate for the collection angle of the projection optics 575. An array of shaped substrate LEDs can comprise shaped substrate LEDs having different shapes and different half-angles arranged to maximize the performance, resolution or picture quality of the display depending upon the application.

Similarly, in an alternative embodiment, the light emitting layers of shaped emitter layer LED or separate optical devices can be sized or shaped to achieve a desired flux per display pixel. In one embodiment, the emitter layer of the shaped emitter LEDs or a separate optical device may be shaped so as to direct the emitted light into a light emission angle congruent with the acceptable angle of the color combining device and/or congruent with a collection angle of the projection optics 575. For example, the emitter layer of shaped emitter layer LEDs or a separate optical device may be shaped so as to emit light with a desired half-angle which is appropriate for the collection angle of the projection optics 575. An array of shaped emitter layer LEDs can include shaped emitter layer LEDs having different shapes and different half-angles arranged to maximize the performance, resolution or picture quality of the display depending upon the application.

While the above embodiment of FIG. 10 was described with regard to LED arrays having LEDs emitting light of a common color, in other embodiments, LEDs arrays may be utilized which have LEDs emitting light of different colors (for example, an LED array may comprise a mix of red, green, blue color light sources). The control program utilized can be configured to allow for the use of LED arrays producing more than one color.

FIG. 11 is a diagrammatic representation of one embodiment of a display system 600 comprising a display controller 605 and a display 610. Display 610 can comprise a circuit board 615 to which LEDs 620 are electrically connected. LEDs 620 can be arranged to form white light units. Controller 605 can include an interface 625 that is electrically connected to LEDs 620 to send control signals to LEDs 620. A processor 630 can execute a set of instructions 635 stored in a computer readable memory 640 to generate control signals to LEDs 620. The intensity of LEDs 620 can be individually controlled to alter the color produced by white light units. By changing the intensity of individual LEDs 620 over time, display 610 can produce moving images. Controller 605 can be implemented as a separate control module, a microprocessor and related hardware, an ASIC and related hardware, or other hardware and/or software suitable to control LEDs. The instructions can be implanted as firmware, software or hardware or according to any other suitable architecture.

While this disclosure describes particular embodiments, it should be understood that the embodiments are illustrative and that the scope of the invention is not limited to these embodiments. Many variations, modifications, additions and improvements to the embodiments described above are possible. For example, the various ranges and dimensions provided are provided by way of example and LEDs may be operable within other ranges using other dimensions. By way of example, while shaped substrates have been described in regard to sapphire and silicon carbide, other substrates that allow the passage of light may be used. For example, substrates may be made of glass or diamond. In one embodiment, substrates may be molded from moldable glass, providing a cost effective and easily shaped substrate. It is contemplated that these variations, modifications, additions and improvements fall within the scope of the claims.

What is claimed is:

1. An LED display comprising:
an array of white light units, each white light unit comprising a set of color light sources, the set of color light sources comprising one or more red light sources, one or more green light sources and one or more blue light sources, wherein each color light source comprises:
a UV LED; and
a phosphor layer adapted to down convert UV light from the UV LED into a corresponding color of light; and
a controller electrically coupled to the white light units, the controller configured to control the white light units to alter the color of light produced by the white light units to produce images on the display.

2. The LED display of claim 1, wherein each color light source comprises a shaped substrate LED having a substrate shaped to emit from an exit face at least 70% of light entering the substrate.

3. The LED display of claim 2, wherein the phosphor layer is disposed on an exit face of the shaped substrate.

4. The LED display of claim 2, wherein each color light source comprises the phosphor layer disposed on a layer of transparent material positioned so that light from the shaped substrate LED will be incident on the phosphor layer.

5. The LED display of claim 1, wherein the each color light source comprises a shaped emitter layer LED.

6. The LED display of claim 5, wherein each color light source comprises the phosphor layer disposed on a substrate of the shaped emitter layer LED.

7. The LED display of claim 1, wherein each color light source comprises a separate optical device coupled to the UV LED and shaped to emit from an exit face at least 70% of the light entering the separate optical device.

8. The LED display of claim 7, wherein phosphor layer of each color light source is disposed on the exit face of the separate optical device.

9. The LED display of claim 7, wherein the phosphor layer of each color light source is disposed on a layer of transparent material positioned so that light from the separate optical device will be incident on the phosphor layer.

10. The LED display of claim 7, wherein the phosphor layer of each color light source is disposed between the UV LED and the separate optical device.

11. The LED display of claim 1, wherein the white light units overlap.

12. The LED display of claim 1, wherein each color light source is configured to emit light into a half angle congruent with a collection angle of a projection lens.

13. An LED display comprising:
an array of white light units, each white light unit comprising a set of color light sources, the set of color light sources comprising one or more red light sources, one or more green light sources and one or more blue light sources, wherein each color light source comprises an LED comprising:
a set of light emitting layers to generate light; and
a substrate comprising:
an entrance interface to receive light generated in the LED;
an exit face at least a minimum distance from the entrance interface so that all rays with a direct transmission path from the entrance interface to the exit face are incident on the exit face at less than or equal to the critical angle; and
a set of sidewalls shaped to reflect a selected percentage of light to the exit face using reflection such that light reflected to the entrance face is incident on the exit face at less than or equal to the critical angle, wherein the size of the exit face and shape of the sidewalls are selected such that at least 70% of the light entering the substrate through the entrance interface will be extracted through the exit face;
a controller electrically coupled to the white light units to control the white light units to alter the color of light produced by the white light units to produce images on the display.

14. The LED display of claim 13 wherein each LED is a UV LED and each color light source comprises a phosphor layer to down convert UV light into a desired color.

15. The LED display of claim 13, further comprising a projection optic wherein each LED has a substrate shaped to emit light with a half angle congruent with an acceptance angle of the projection optic.

16. The LED display of claim 13, wherein each LED has the minimum size necessary to conserve radiance.

17. An LED display comprising:
a projection optic;
a color combiner;
an array of red light sources;
an array of green light sources; and
an array of blue light sources;
wherein the array of red light sources, green light sources and blue light sources are configured to provide light to the color combiner in a desired half angle and the color combiner is configured to combine light from the array of red light sources, the array of green light sources and the array of blue light sources into a common plane for transmission to the project optic.

18. The LED display of claim 17, wherein each light source comprises an LED comprising:
a set of light emitting layers to generate light; and
a substrate comprising:
an entrance interface to receive light generated in the LED;
an exit face at least a minimum distance from the entrance interface so that all rays with a direct transmission path from the entrance interface to the exit face are incident on the exit face at less than or equal to the critical angle; and
a set of sidewalls shaped to reflect a selected percentage of light to the exit face using reflection such that light reflected to the entrance face is incident on the exit face at less than or equal to the critical angle, wherein the size of the exit face and shape of the sidewalls are selected such that at least 70% of the light entering the substrate through the entrance interface will be extracted through the exit face.

19. The LED display of claim 18, wherein each light source further comprises a phosphor layer to down convert light generated by the LED to a desired color.
